(19) United States
(12) Patent Application Publication
(10) Pub. No.: US 2021/0371293 A1
(43) Pub. Date: Dec. 2, 2021

(54) Installation and Method for Separating at Least One Ionic Species from a Solution Comprising at Least Said Ionic Species and Lithium

(71) Applicant: GEOLITH, La Celle Saint-Cloud (FR)

(72) Inventor: Jean-Philippe Gibaud, La Celle Saint-Cloud (FR)

(73) Assignee: GEOLITH, La Celle Saint-Cloud (FR)

(21) Appl. No.: 17/285,121

(22) PCT Filed: Oct. 14, 2019
(86) PCT No.: PCT/EP2019/077823

§ 371 Date: Apr. 14, 2021

(30) Foreign Application Priority Data
Oct. 18, 2018 (FR) 1871216

(51) Int. Cl. C01D 15/08; B01D 15/36; C02F 1/42; C22B 3/42; C22B 26/12; B01J 45/00; B01J 49/06; B01J 49/50

(52) U.S. Cl. CPC C01D 15/08; B01D 15/362; C02F 1/42; C22B 3/42; C02F 2101/10; B01J 45/00; B01J 49/06; B01J 49/50; C02F 2001/425; C22B 26/12

(57) ABSTRACT

The installation for separating a multivalent cationic species from a solution comprising this multivalent cationic species and lithium comprises a capture device (3) having an entry (2) and an exit (4). The capture device (3) comprises, between the entry (2) and the exit (4), a microfibre product (12) with a higher affinity for multivalent cations than for monovalent cations. The installation comprises a circulation system (5) adapted to circulate the solution from the entry (2) to the exit (4) in contact with the microfiber product (21), the microfibre product (21) capturing said multivalent cationic species.

### FIELD OF THE INVENTION

The present invention relates to an installation and a method for separating at least one ionic species from a solution comprising at least said ionic species and lithium.

### BACKGROUND

More specifically, the invention relates to the recovery of lithium.

Lithium is a widely used material, for example in the manufacture of batteries. There are several methods to obtain lithium. According to one example, lithium is recovered from salars, which are large areas comprising accumulations of salts from which saline aqueous solutions are extracted, from which lithium is extracted from the other cations contained in solution. These methodes are essentially by evaporation. However, the yield of lithium is quite low because a good part of it precipitates during the evaporation step which aims at reducing the magnesium content in the solution.

Document EP 0 785 170 is placed in a different context, namely that of the manufacture of lithium zeolite products used for the separation of nitrogen and air. The effluents of this manufacturing method, which are highly concentrated in lithium, are treated with powders.

Document US 2014/334,997 discloses a method of purifying a solution of lithium bicarbonate which is carried out on a solution stored under a high pressure of carbon dioxide.

Document DE 100 08 940 discloses a filter made from polypropylene microfibers. The technical effect allowing the purification of the component to be removed is not described. It states that polypropylene is notoriously chemically inert. Therefore, the filtering effect is likely achieved by a simple mechanical effect of retention of the larger particles.

Document EP 2 522 631 describes a separation of lithium and magnesium contained in solution by means of a gel. The separation of the species is based on the size of the species facilitating their diffusion in the resin.

The present invention thus aims to improve the separation of ionic species contained in solutions containing lithium, especially aqueous solutions containing lithium such as, for example, lithium brines.

### SUMMARY OF THE INVENTION

Thus, the invention relates to an installation for separating at least one multivalent cationic species from a solution comprising at least said multivalent cationic species and lithium, said separation installation comprising:

at least one capture device comprising an entry and an exit, the capture device comprising, between the entry and the exit, a ion exchange microfiber product having a higher affinity greater for multivalent cations than for the monovalent cations,

a circulation system adapted to circulate the solution from the entry to the exit in contact with the microfiber product, said microfiber product capturing said multivalent cationic species.

With these provisions, lithium can be separated from a divalent cation remaining in the solution at the entry of the installation. The divalent cation is captured, while the lithium remains in the solution. In addition, because of the ion exchange phenomenon, a cation is released, which may be lithium, or another cation that is easier to separate from lithium than the divalent cation.

According to various aspects, it is possible to provide for one and/or the other of the following provisions.

In one embodiment, the separation installation further comprises a recirculation device adapted to circulate a portion of the solution from the exit to the entry without passing through the microfiber product.

According to one embodiment, the capture device comprises a plurality of individual capture cells connected in series, the capture cells comprising the microfiber product, the individual capture cells connected in series comprising different saturation rates in said ion species, and in particular in which the saturation rates are decreasing from upstream to downstream.

In one embodiment, the microfiber product comprises lithium, and the microfiber product captures said at least one multivalent cationic species while releasing lithium.

In one embodiment, the separation installation further comprises a regeneration system comprising a regeneration circulation device adapted to circulate a release product in contact with the microfiber product, said microfiber product then releasing said multivalent cationic species.

In one embodiment, the regeneration circulation device is adapted to circulate a recharge product comprising lithium and/or Sodium in contact with the microfiber product, said microfiber product then charging with lithium and/or Sodium, respectively.

In one embodiment, the separation installation comprises valves adapted to allow or prohibit the circulation of solutions in different circuits, and pumps to generate a circulation, and a controller programmed to control the valves.

In one embodiment, the separation installation contains an atmosphere at the microfiber product, the carbon dioxide content is less than 0.1% for a total pressure of less than 10 bar.

According to one embodiment, the separation installation comprises, in contact with the capture device, a lithium halide solution, especially chloride, bromide and/or iodide, lithium sulphate, lithium carbonate CO₃²⁻, lithium nitrate and/or lithium hydroxide, the lithium bicarbonate content is less than 1%, especially less than 0.1% by weight.

According to another aspect, the invention relates to a CO₃²⁻ Lithium Carbonate production installation comprising:
Such a separating installation, providing a solution comprising lithium,
A subsequent processing unit treating said solution comprising lithium and producing lithium carbonate CO₃²⁻.

According to another aspect, the invention relates to a cell for capturing at least one multivalent cationic species from a solution comprising at least said multivalent cationic species and lithium, said capture cell being intended to equip a capture device of such a separation installation, said capture cell comprising:

an entry,

an exit,

between the entry and the exit, a microfibre product having a greater affinity for multivalent cations than for monovalent cations.

According to another aspect, the invention relates to a unit for capturing at least one multivalent cationic species from a solution comprising at least said multivalent cationic species and lithium, said capture unit comprising a plurality of such capture cells, a circulation system adapted to hydraulically connect said capture cells to one another, the circulation device comprising valves and pumps adapted to be controlled from a controller.

According to another aspect, the invention relates to a method for separating at least one multivalent cationic species from a solution comprising at least said multivalent cationic species and lithium, said separation method comprising:

at least one capture device comprising an entry and an exit is provided, the capture device comprising, between the entry and the exit, a microfiber product having a higher affinity for multivalent cations than for monovalent cations,

with a circulation system, the solution is passed from the entry to the exit in contact with the microfiber product, said microfiber product capturing said multivalent cationic species.

In one embodiment, there is provided a solution of lithium halide, including chloride, bromide and/or iodide, lithium sulphate, lithium carbonate CO₃²⁻, lithium nitrate and/or lithium hydroxide, the Lithium bicarbonate content of which is less than 1%, and especially less than 0.1% by weight.

In one embodiment, the atmosphere at the microfiber product has a carbon dioxide content of less than 0.1% for a total pressure of less than 10 bar.

According to another aspect, the invention relates to a method for manufacturing CO₃²⁻ lithium carbonate comprising such a separation method, and wherein the solution is subjected to subsequent treatment by a subsequent treatment unit.

According to another aspect, the invention relates to a method of regeneration of a microfiber product used for the separation of at least one multivalent cationic species from a solution comprising at least said ionic species and lithium, in which:

a regeneration circulation device circulates a release product in contact with the ion exchange microfiber product, said microfiber product then releasing said multivalent cationic species,

the regeneration circulation device circulates a recharge product comprising lithium in contact with the microfiber product, said microfiber product then charging with lithium.

According to another aspect, the invention relates to a method for treating a solution comprising a multivalent cationic species and lithium, said method comprising applying in a cyclic manner such a method of capturing said multivalent cationic species and a such regeneration method.

### BRIEF DESCRIPTION OF THE DRAWINGS

Embodiments of the invention will be described below with reference to the drawings, briefly described below:

FIG. 1 is a schematic representation of a lithium recovery method from a salar.

FIG. 2 is a schematic view of an exemplary implementation of a method step.

FIG. 3 is a schematic view of an exemplary implementation of a method step.

FIG. 4 is a schematic view of an exemplary implementation of a method step.

FIG. 5 is a schematic view of an exemplary implementation of a method step.

FIG. 6 is a schematic view of an exemplary implementation of a method step.

FIG. 7 is a schematic view of an exemplary implementation of a method step in a step subsequent to the step shown in [FIG. 6].

FIG. 8 is a partial schematic view of an installation according to one embodiment.

FIG. 9 is a schematic view of an exemplary cell used for the implementation of the method.

FIG. 10 is a schematic plan view of a two-dimensional product used in the installation.

FIG. 11 is a basic view of the uptake of a metal ion by a fiber.

FIG. 12 is an exploded schematic view of a portion of a capture cell.

FIG. 13 is a partial perspective view of an installation according to a second embodiment.

FIG. 14 schematically represents in cross-section another exemplary embodiment of a capture cell.

In the drawings, like references designate identical or similar objects.

### Definitions

For a chemical reaction, the term A=Σvᵢμᵢ is called “affinity”, where vᵢ is the stoichiometric coefficient of species i and μᵢ is the chemical potential of species i.

A “capture cell” is an elementary object capable of implementing the capture described in this document.

A “capture unit” is an autonomous object, comprising a capture cell, or a plurality of capture cells connected together in a functional manner, as well as means for implementing the method (fluidic connections, controllers, etc.) so as to form a functional whole that can be integrated into an installation comprising one or more capture units.

The term “capture device” is used generically to refer to any object that may implement the capture described in this document. It can thus designate both a “capture cell” or a “capture unit”, or include one or more of these objects connected together in a functional manner.

### DETAILED DESCRIPTION

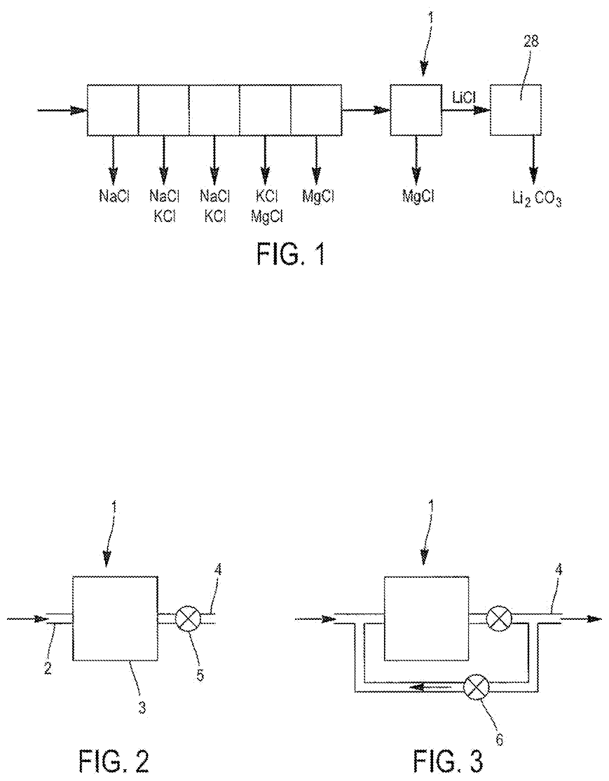

In a first step, the invention is presented in its application to a first embodiment, relating to the recovery of lithium from a salar. FIG. 1 shows schematically the lithium recovery method from a salar. The input component of the method is a brine, or saline aqueous solution, from the salar. The saline aqueous solution is concentrated in salts. It includes in particular important concentrations of chlorides, as well as sodium, potassium, magnesium and lithium cations. By way of example, the brine to be treated at the following concentrations:

0.1 to 3 g/l of lithium,

0.5 to 50 g/l of magnesium,

20 to 200 g/l of sodium,

5 to 50 g/l of potassium.

During a first step, the brine went from evaporation basin to evaporation basin. In each basin or group of basins, during evaporation, different salts precipitate. In particular, and successively, the following salts precipitate:

sodium chloride (first basin),

sodium chloride and potassium chloride (second and third basins),

potassium chloride and magnesium chloride (fourth basin),

Magnesium chloride, as well as the beginning of precipitation of lithium chloride (fifth basin).

At the end of these precipitation stages, the lithium only slightly precipitated, so that its relative concentration in the brine increased compared with other cations. For example, at the end of these steps, the brine may have the following concentrations:

10 to 70 g/l of lithium, and in particular 50 g/l of lithium,

10 to 250 g/l of magnesium,

1 to 5 g/l of sodium,

1 to 5 g/l of potassium.

Thus, the ratio of Li/Mg concentrations in the solution has substantially increased during these evaporation steps.

At this stage, Lithium is present in the solution in the form of a halogenide (chloride, bromide or iodide) of lithium, a lithium sulphate, a lithium monocarbonate, Lithium Nitrate, and/or Lithium Hydroxide. Lithium bicarbonate ions, which are not stable in aqueous solution, may be present in trace amounts, in any event in a concentration of less than 1%, or even less than 0.1% by weight.

The method that is the subject of the present invention finds its application, according to one embodiment, in the separation of the lithium resulting from this last precipitation step. It is about refining the lithium from the important concentration of magnesium remaining in the solution. The present method can be referred to as “purification” or “refining”. This step could alternatively be done by precipitation, according to prior publicly known methods, but the precipitation dynamics of the two species overlap, and a significant amount of lithium is lost during the precipitation of magnesium.

FIG. 2 schematically shows a separation facility 1 according to a first embodiment. The separation installation 1 comprises an entry 2, a capture device 3 downstream of the entry, and an exit 4 downstream of the capture device 3. A circulation system 5 circulates the fluid from the entry 2, through the capture device 3, to the exit 4, at a suitable rate. The treatment can be carried out in atmospheric air. Alternatively, the treatment can be carried out under a controlled atmosphere. In this case, the controlled atmosphere does not need to be rich in carbon dioxide. A carbon dioxide content of less than 0.1% is possible at a total pressure less than 10 bars. The brine to be treated can be diluted with treated brines (treatment described below) from the further processing unit 28. Schematically, the circulation system 5 is shown in FIG. 2 between the capture device 3 and the exit 4, however, it could be done in any suitable manner, including one or more pumps distributed in various locations necessary for fluid flow.

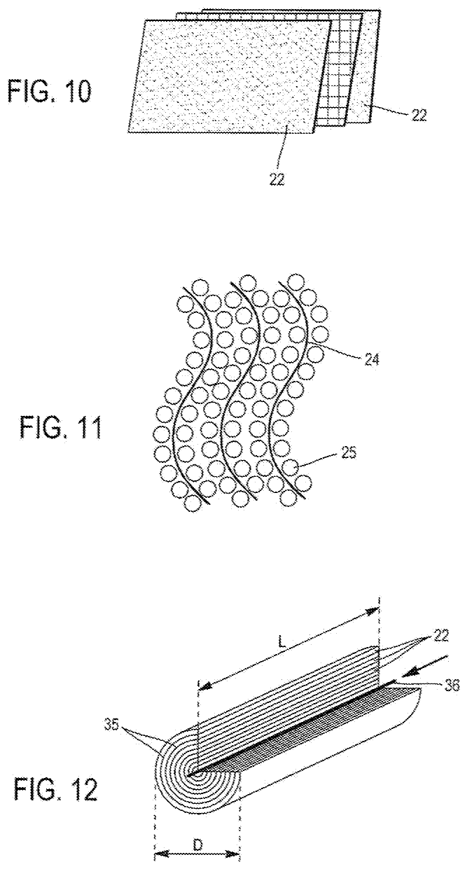

The capture device 3 comprises a microfiber product adapted to the separation of some of the ion species from the solution present at the entry. The microfiber product is in the form of a volume product made from one or more fibers arranged to form a compact solid package. A product is considered “volume” if its three dimensions have sizes of similar order of magnitude. The volume product may be manufactured from a two-dimensional product 22, folded on itself several times, or several layers of which are assembled together, as represented for example in FIG. 10. The two-dimensional product, for its part, is realized from fibers. The two-dimensional product comprises, for example, a nonwoven, a fabric or a felt. A fiber is a flexible product whose length is much greater than the other two dimensions. In the example presented, it has a circular section. However, other achievements are possible. In this case, the transverse dimension (diameter) of the fiber is of the order of 1 micrometer to 200 micrometers, especially between 10 and 40 micrometers. The fibers can be used raw for producing the two-dimensional product, or processed to produce non-woven felt, yarn, or woven, which is then used for producing the two-dimensional product. The fibers have the advantage that, in a given volume, they have a large surface area, while being easy to keep in a container, especially in comparison with conventionally used powders comprising beads having a diameter of the order of 0.1 mm to 2 mm. According to one exemplary embodiment, the use of the microfibers makes it possible to obtain a specific surface area of at least greater than 50 square meters per liter, or even at least 100 m²/l, where the specific surface area refers to the area of the free surface of the fibers contained in a volume of 1 liter.

Fibers are ion exchange fibers. These fibers contain, and especially may be made of, a material with high affinity for multivalent cations. In particular, according to this embodiment, this material has a high affinity for the Mg²⁺ ion. In one embodiment, this material is loaded with lithium. Lithium is present as a ion used for ion exchange. The fiber is insoluble in an aqueous solution. The term “insoluble” means that the fiber morphology does not undergo detectable changes using an electron microscope after at least 24 hours of immersion in a substantially aqueous solution. In addition, the fibers are porous with water. This feature allows water to access the chemical reaction sites within the fibers.

According to a first example, the fiber is a polymer fiber carrying carboxylic acid functional groups. These acidic groups can be de-protonated in a basic medium and can be converted into a carboxylate ion accompanied by a cationic counterion. These carboxylate ions prefer to be accompanied by multivalent cations. This “accompanying” cation can be released by acidification, in which case the carboxylate ion becomes carboxylic acid again.

According to a second example, the fiber is a polymer fiber bearing iminodiacetic acid functional groups. These groups play the role of chelating clamp. They have a very strong tendency to complex multivalent cations. This “accompanying” cation can be released by strong acidification.

According to a particular case, it is possible, for example, to use the fibers marketed, on the priority date, by AJELIS, under the names METALICAPT®-MFB or METALICAPT®-MFD.

According to an independent aspect, an invention relates to a fiber, as presented above, charged with lithium.

As shown schematically in FIG. 11, the fibers 24 have a large exchange surface per total volume of microfiber product. This makes it possible to fix a large number of cations 25. This characteristic makes it possible to envisage an efficiency of the ion exchange method compatible with the lithium/magnesium separation application, which is greater than that of traditional resin-based ion exchange technologies. Moreover, the fibrous nature of the material, despite its large exchange surface, leaves large areas of passage, and consequently generates a low pressure drop (low resistance to flow, low energy consumption).

The microfiber product, before use, is dry, and can be stored and transported dry, which is not the case for “conventional” ion exchange resins which must be transported and stored at a high rate of moisture content, subject to losing their characteristics.

Thus, in one mode of production, the circulation system 5 circulates the fluid in contact with the microfiber product as it passes from the inlet to the outlet. The microfiber product has more affinity for magnesium (divalent) cations than for lithium (monovalent) cations. In contact with the microfiber product, the magnesium of the solution is captured by the material at sites previously loaded with lithium, which is thus released. The lithium initially present in the solution is not captured by the microfiber product, and proceeds to the exit 4. Selective capture of Magnesium is thus carried out.

To increase the efficiency of the capture of magnesium, a solution comprising an optimum concentration of magnesium (function of the capture capacity, the residence time, and/or the reaction kinetics) may be entered. The optimum concentration may depend on the configuration of the capture device 3, but may typically be in the range of 100-10,000 mg/l, and in particular of 500-5,000 mg/l or 1,000-10,000 mg/l.

This concentration can for example be obtained by diluting the solution upstream of the inlet. For example, the solution can be diluted with water. Alternatively, and as shown in FIG. 3, the solution can be diluted with the solution leaving the capture device 3. Thus, by means of a recirculation device 6, a portion of the solution at the exit of the capture device 3, depleted in magnesium, to the entry 2, where it dilutes the initial solution, without major modification of the concentration of other salts and in particular lithium.

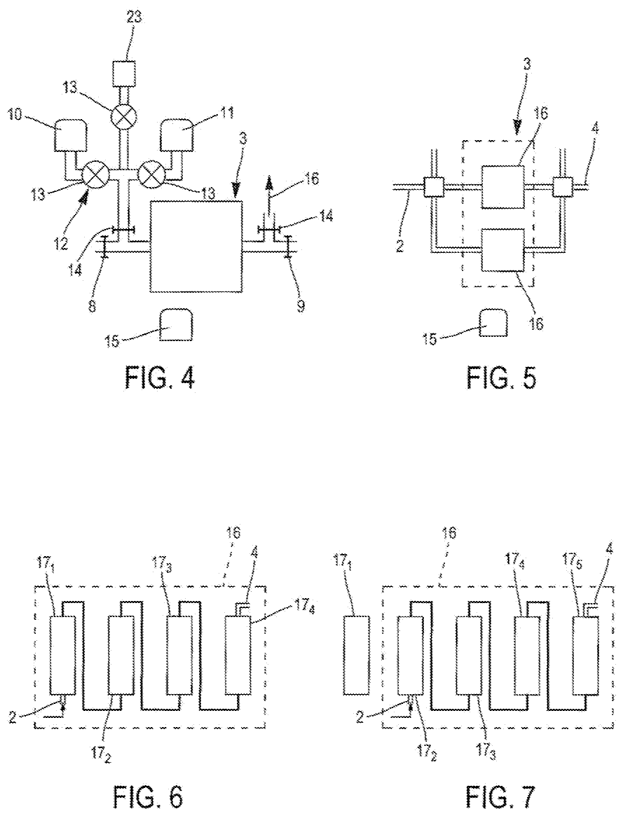

The separation installation also comprises a regeneration system 7, shown in FIG. 4 in the context of the embodiment of FIG. 2 (this system being compatible also with the embodiment of FIG. 3). As shown in FIG. 4, the circulation system 5 also comprises an inlet valve 8 fitted to the entry 2 and controllable to alternatively allow or prohibit entry of the solution into the capture device 3. The system circulation 5 also includes an outlet valve 9, equipping the exit 4, and controllable to alternatively allow or prohibit the exit of the solution from the capture device 3 to the exit.

The regeneration system 7 comprises a source of release product 10, adapted to discharge cations from the microfiber product. The release product comprises, for example, an acid, of pH at most equal to 4, such as a hydrochloric acid solution. The regeneration system 7 comprises a source of recharge product 11, adapted to charge the microfibre product with cations. The recharge product comprises for example a base, such as for example a solution of lithium hydroxide or lithium carbonate, of pH at least equal to 9. The regeneration system 7 comprises a source of rinsing product 23, adapted to rinse the microfiber product and remove the components that may have a negative influence on the rest of the method. The rinsing product comprises, for example, water. The regeneration system 7 comprises a regeneration circulation device 12 adapted to circulate the fluids through the capture device 3. The regeneration circulation device 12 may comprise pumps 13, and valves 14 arranged on the different channels and adapted to alternatively allow or prohibit the flow of fluid in this channel.

A controller 15 controls the valves 8, 9, 14 and the pumps according to a preprogrammed procedure, to provide regeneration. In the embodiment shown, there is shown a single microfiber product. However, the microfiber product can be installed in several columns independent of each other. In this case, according to the embodiments, a valve may be installed for a single column or for a group of columns (typically a group of columns may comprise from two to several hundred columns).

During a releasing step, the inlet 8 and outlet 9 valves are closed. The release fluid is circulated from the source of release product 10 through the capture device 3. During this step, the Magnesium captured by the microfiber product is released from it, and circulated outwardly.

During a charging step, the recharge product is circulated from the source of recharge product 11 through the capture device 3. In this step, the microfiber product is recharged with lithium. In the case where the recharge product is lithium hydroxide, it interacts with the microfiber product to charge it with lithium. Lithium hydroxide is circulated to the outside 16.

A rinsing step may be carried out using the rinsing product 23 before and after each of these steps and the production steps (rinsing the residual solution, the residual acid, the residual base).

A purge system may be provided, for example under compressed air, after each step to remove the residual liquid.

The ion exchange mechanism, in the case of a fiber with carboxylic acid groups, and of a Magnesium and Lithium chloride effluent, can be summarized as follows:

Separation Stage:

(2COO⁻,2Li⁺)_{fibers}+(Mg²⁺,Li⁺,Cl⁻)_{circulating}->(2COO⁻,Mg²⁺)_{fibers}+(Li⁺,Cl⁻)_{circulating}

Release Step:

(2COO⁻,Mg²⁺)_{fibers}+(H⁺,Cl⁻)_{circulating}->(2COOH)_{fibers}+(Mg²⁺,H⁺,Cl⁻)_{circulating}

Refill Step:

(2COOH)_{fibers}+(Li⁺,OH⁻)_{circulating}->(2COO⁻,2Li⁺)_{fibers}+(Li⁺,OH⁻)_{circulating}+H₂O

The method which has just been described makes it possible to cyclically treat the incoming solution.

A capture cell capable of implementing the above method is shown in FIG. 9. In FIG. 9, the capture cell 17 is hydraulically connected to the entry 2 at a first side of the capture cell 17. It is hydraulically connected to the exit 4 in a second side of the capture cell 17, opposite the first side. The capture cell 17 is hydraulically connected, on the second side, to recharge tanks 29, 29′, a release agent tank 30 and a rinsing tank 31. It is hydraulically connected, on the first side, to recharge product return circuits 32, 32′, a release product return circuit 33, and a rinsing product return circuit 34. Thus, the products of recharge, release and rinse circulate in the capture cell 17, in the opposite direction to the solution to be treated.

In the example above, the separation step must be stopped during the regeneration of the capture device 3. Alternatively, it can be provided, as shown in FIG. 5, that the capture device 3 comprises several capture units 16 each designed as the capture device 3 described above, and connectable alternately with the main circuit and with the regeneration circuit. Thus, it is possible to use a capture unit 16 for capturing the Magnesium of the incoming solution and, in parallel, to regenerate another capture unit 16. Then, after a certain time, the roles are exchanged. The method is cyclically repeated. In this way, the method is made continuous, and allows to receive at the entry a continuous flow of solution to be treated and to produce a final solution also in continuous flow. The system is controlled by the controller 15. The total number of units, and the sequencing of implementation, will depend on the time required to implement each of the steps of production, rinsing, releasing, recharging, purge, valve control, or any other necessary step and the expected volume/flow of production.

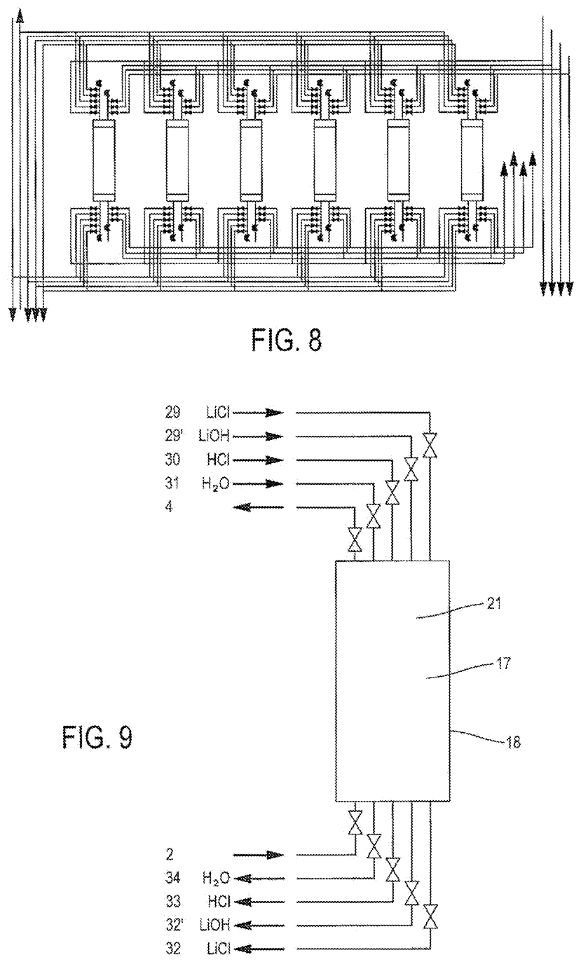

FIG. 8 describes an alternative embodiment with six cells. Thus, with respect to FIG. 9, the capture cells 17 comprise additional lines, making it possible to alternately connect the input side of a capture cell 17 either directly with the entry 2 or with an upstream capture cell. With respect to FIG. 9, the capture cells 17 also comprise additional lines, making it possible to alternatively connect the exit side of a capture cell 17 either directly to the exit 4 or to a downstream capture cell.

Over time, the microfiber product charges with Magnesium. With increasing concentration of magnesium captured, the ability of magnesium absorption by the microfiber product decreases. Thus, one may be tempted to place the microfiber product in regeneration mode earlier, in order to eliminate a maximum concentration of Magnesium. However, in this case, the capture phase and the regeneration phase are rapidly alternated, which affects the overall efficiency of the system. The controller 15 is programmed to operate at an optimum and adjustable operating point for each site.

An alternative embodiment is shown in FIG. 6. FIG. 6 shows a capture unit 16 in the capture phase. The capture unit 16 comprises a plurality of capture cells 17₁, 17₂, 17₃, 17₄. The capture cells may be designated by the generic reference 17. For the example, four capture cells are described, but the number could be different, typically between two and ten or more. Each capture cell is designed as the capture device 3 described above, except that the capture cells are interconnected in series. In a particular case, along the path of the solution from the entry 2 to the exit 4, the capture cells have a decreasing magnesium saturation. That is, the capture cell 17₁ connected to the entry is more saturated with Magnesium than the next, and so on, until the exit.

In this embodiment, when the capture cell 17₁ is saturated with Magnesium beyond a predetermined saturation threshold, it is no longer used for the implementation of the capture step 16. The entry 2 is then connected to the remaining most saturated Magnesium capture cell, that is, a priori, the capture cell 17₂. Where appropriate, simultaneously or subsequently, a capture cell 17₅ resulting from the regeneration step, with low magnesium saturation, is connected downstream of the capture cell 17₄ upstream of the exit 4, as visible in FIG. 7. The capture cell 17₁ undergoes the regeneration method. The capture step is then implemented with the capture cells 17₂, 17₃, 17₄, 17₅. All of the above steps can be obtained by a suitable control of the valves by the controller 15, without any displacement of the cells or pipes. This implementation makes it possible to increase the overall productivity of the method.

FIG. 9 schematically shows an exemplary capture cell 17 according to one embodiment. The capture cell 17 comprises a rigid enclosure 18. The microfiber product 21 is disposed inside the enclosure 18. According to an exemplary embodiment, the capture cell 17 comprises a mechanical holding system (not shown) holding the microfiber product 21 in place despite the fluid flow through the capture cell 17. As shown in FIG. 9, flow of the solution to be treated in one direction through the capture cell 17, and flow of the other fluids in the opposite direction is provided. The capture cell 17 is hydraulically connected, via dedicated valves, to the entry 2 and exit 4 of the solution to be treated, to two tanks of recharge product 29, 29′, to a reservoir of release product 30 and to a reservoir of rinsing product 31. It is also hydraulically connected to returns of recharge product 32, 32′, release product 33, and rinsing product 34 downstream of the capture cell 17.

According to an exemplary embodiment, as shown in FIG. 12, two-dimensional products 22 are stacked with the interposition of holding devices that now mechanically hold the two-dimensional products while allowing fluid flow of the solutions through the cell. The holding devices 35 comprise, for example, flexible perforated spacers made of any suitable material. The assembly is shaped, for example by cutting, folding, and winding around a central core 36 and fixed in the enclosure 18. Other embodiments are possible.

FIG. 8 thus shows the implementation of six cells, each as described above in relation to FIG. 9, so as to implement the different steps of the phases described above. Of these, the solution entry valve of some cells is connected to the entry 2 via the exit of an upstream cell. Of these, the solution exit valve of some cells is connected to the exit 4 via the entry of a downstream cell.

FIG. 14 schematically shows another embodiment of a capture cell 17, operating radially. The capture cell 17 has a cylindrical architecture, with a circular section or other section, whose outer radial surface 37 constitutes an entry for the solution (see arrows in FIG. 14). The micro-fiber product 21 is disposed between the outer radial surface 37 and an exit. The exit is for example made by an axial duct 38, surrounded by the micro-fiber product 21. The circulation device circulates the solution, in production mode, from the entry to the exit. In this embodiment, the capture cell provides a large exchange surface to the solution. As for the first exemplary embodiment, the regeneration step would be implemented by a flow of fluids in the opposite direction through the capture cell 17. The exit can be connected, downstream, to another cell.

The capture cells 17 described above may, depending on the embodiments, be surrounded by a mechanical action filter element, of the microfiber or micro-perforated film type, for the retention of any particles contained in the solution, resulting for example from precipitations during prior method steps.

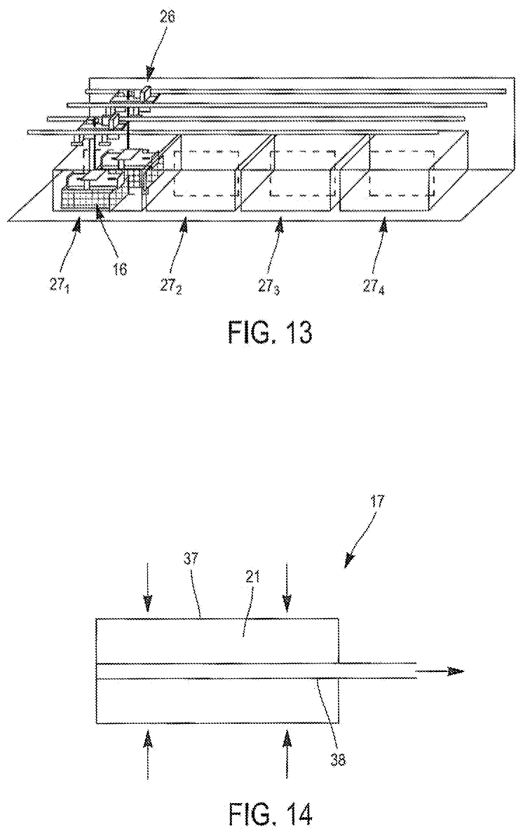

FIG. 13 shows a second embodiment of an installation. According to this embodiment, the installation comprises several stations each dedicated to a particular task, and separated from each other in space. In this example, each station comprises a basin in which a solution is contained. A capture unit 16 is transported by a transport device 26 from station to station, for the purpose of the method. The capture unit is immersed in the solution at the station. It is thus possible to provide a small number of valves to control the method. Indeed, for example, it is sufficient to equip each station with a single entry valve and a single exit valve, the capture unit 16 comprising any number of capture cells connected together in a fixed manner, in series and/or in parallel. Moreover, depending on the magnesium concentration in the solution present in the basin, the chronology of the movements of the capture units 16 can change.

According to the simplified example shown, the installation comprises a treatment station 27₁, a rinsing station 27₂, a release station 27₃, and a charging station 27₄, and the unit 16 is moved from station to station according to the needs of the method. If the method implements the serialization of several cells during the processing step, as explained above in relation with FIGS. 6 and 7, then the installation may comprise several stations each corresponding, at a given moment, to a different magnesium concentration level. Over time, in the same station, the magnesium concentration of the solution contained in the basin will decrease. At a certain stage, a pond will be emptied, then filled with a solution very charged with magnesium. The sequence of movement of the basin units 16 in the basin will then be modified, to follow the rule that a unit must be dipped successively into basins having a magnesium concentration increasing over time.

Alternatively, the material constituting the fibers is loaded with Sodium. Sodium is present as a ion used for ion exchange.

In this case, the ion exchange mechanism, in the case of a fiber with carboxylic acid groups, can be summarized as follows:

Separation Step:

(2COO⁻,2Na⁺)_{fibers}+(Mg²⁺,Li⁺,Na⁺,Cl⁻)_{circulating}->(2COO⁻,Mg²⁺)_{fibers}+(Li⁺,Na⁺,Cl⁻)_{circulating}

Release Step:

(2COO⁻,Mg²⁺)_{fibers}+(H⁺,Cl⁻)_{circulating}->(2COOH)_{fibers}+(Mg²⁺,H⁺,Cl⁻)_{circulating}

Refill Step:

(2COOH)_{fibers}+(Na⁺,OH⁻)_{circulating}->(2COO⁻,2Na⁺)_{fibers}+(Na⁺,OH⁻)_{circulating}+H₂O.

This variant can in particular be used if the presence of Sodium in the solution resulting from the method is not a problem for the subsequent stages of the lithium carbonate manufacturing method. It can especially be used if the input solution already includes a significant amount of Sodium.

As shown in FIG. 1, the solution resulting from the method described above is subjected to a subsequent treatment by a further processing unit 28, leading to the production of lithium carbonate Li₂CO₃. This treatment may for example include an addition of calcium oxide to precipitate magnesia, and include different successive stages of sedimentation, filtration and precipitation, and a final step of drying and then cooling. As discussed above, the recovered liquids can be re-integrated at the entry of the separation installation 1. The separation method can be implemented on site after the evaporation method in the evaporation basins. At the end, the Lithium-rich solution is led to a refinery for the implementation of the subsequent steps. Alternatively, the separation method is carried out near the refinery. The input solution is conducted from the evaporation basins to the refinery, where it is processed by carrying out the present method first.

### Examples

A test was carried out in the laboratory with a capture unit comprising six capture cells connected in series as described above in relation with FIG. 6, the capture unit implementing the principle of recirculation explained in connection with FIG. 3. Each capture cell, with a capacity of 8 ml, contains 1.5 g of microfiber product.

The input solution is a solution from an evaporation basin of a South American salar, and having the following composition:

Li: 1.69%

Mg: 5.87%

Li/Mg ratio: 0.29

The microfibre product comprises METALICAPT®-MFD fibers obtained in bulk from AJELIS, placed in an enclosure forming the cell. The Magnesium concentration, in the initial solution, as in samples of the output solution, is measured from a C200 Hanna Instrument multiparameter spectrophotometer.

For an input sample with a magnesium concentration close to 100,000 mg/l, and a dilution by 40 by recirculation, the resulting magnesium content in the exit solution, before saturation, is substantially constant and less than 50 mg/l.

The treatment method which has just been described in an Mg/Li separation application in a brine from a salar can alternatively be used for any brine from which a divalent ion such as magnesium (Mg²⁺), calcium (Ca²⁺), strontium (Sr²⁺), barium (Ba²⁺), etc is to be extracted.

The method which has just been described can also be implemented for the separation of barium or strontium.

Typically, in one application example, the flow velocity through the installation is in the range of 1 to 100 m³/m²/h, where cubic meters refer to the volume of solution passing through the installation, the square meters are the equivalent effective cross section of the capture device orthogonally to the direction of flow, and the time is expressed in hours.

### REFERENCES

Separation installation (1)
Entry (2)
capture device (3)
exit (4)
circulation system (5)
recirculation device (6)
regeneration system (7)
inlet valve (8)
outlet valve (9)
release product (10)
recharge product (11)
regeneration circulation device (12)
pumps (13)
valves (14)
controller (15)
capture unit (16)
capture cell (17)
enclosure (18)
microfiber product (21)
two-dimensional product (22)
source of rinsing product (23)
fiber (24)
cation (25)
transport device (26)
treatment station (27₁)
rinsing station (27₂)
release station (27₃)
charging station (27₄)
further processing unit (28)
recharge tanks (29), (29′)
release agent tank (30)
rinse tank (31)
recharge product return (32), (32′)
return of release product (33)
return of rinsing product (34)
holding devices (35)
central core (36)
outer radial surface (37)
axial duct (38)

What is claimed is:

1. Separation installation for separating at least one multivalent cationic species from a solution comprising at least said multivalent cationic species and lithium,
said separation installation (1) comprising:
at least one capture device (3) comprising an entry (2) and an exit (4), the capture device (3) comprising, between the entry (2) and the exit (4), an ion exchange microfiber product (21) having a higher affinity for multivalent cations than for monovalent cations,
a circulation system (5) adapted to circulate the solution from the entry (2) to the exit (4) in contact with the microfiber product (21), said microfiber product (21) capturing said multivalent cationic species.

2. Separation installation according to claim 1, further comprising a recirculation device (6) adapted to circulate a portion of the solution from the exit (4) to the entry (2) without passing through the microfiber product (21).

3. Separation installation according to claim 1, wherein the capture device (3) comprises a plurality of individual capture cells (17) connected in series, said capture cells comprising the microfiber product, the individual capture cells (17) connected in series comprising different saturation rates in said ion species, and in particular in which the saturation rates are decreasing from upstream to downstream.

4. Separation installation according to claim 1, wherein the microfiber product (21) comprises lithium, and wherein the microfiber product (21) captures said at least one multivalent cationic species while releasing lithium.

5. Separation installation according to claim 1, further comprising a regeneration system (7) comprising a regeneration circulation device (12) adapted to circulate a release product (10) in contact with the microfiber product (21), said microfiber product (21) then releasing said multivalent cationic species.

6. Separation installation according to claim 5, wherein the regeneration circulation device (12) is adapted to circulate a recharge product (11) comprising lithium and/or sodium in contact with the microfiber product (21), said microfiber product (21) then charging with lithium and/or sodium, respectively.

7. Separation installation according to claim 1, comprising valves (14) adapted to allow or prohibit circulation of the solution in different circuits, pumps (13) for generating circulation, and a controller (15) programmed to control the valves (14).

8. Separation installation according to claim 1, containing an atmosphere, at the microfiber product, where the carbon dioxide content is less than 0.1% at a total pressure of less than 10 bars.

9. Separation installation according to claim 1, comprising, in contact with the capture device, a lithium halogenide solution, especially chloride, bromide and/or iodide, lithium sulphate, Lithium monocarbonate, Lithium Nitrate and/or Lithium Hydroxide, the lithium bicarbonate content of which is less than 1%, and notably less than 0.1% in mass.

10. Lithium Carbonate production installation comprising:
a separation installation according to claim 1, providing a solution comprising lithium,
a subsequent processing unit (28) treating said solution comprising lithium, and producing lithium carbonate.

11. Capture cell for capturing at least one multivalent cationic species from a solution comprising at least said multivalent cationic species and lithium, said capture cell being intended to equip a capture device of a separation installation according to claim 1, said capture cell (17) comprising:
an entry,
an exit,
between the entry and the exit, a microfiber product (21) having a greater affinity for multivalent cations than for monovalent cations.

12. Capture unit for capturing at least one multivalent cationic species from a solution comprising at least said multivalent cationic species and lithium, said capture unit (16) comprising a plurality of capture cells (17) according to claim 10, a circulation system (5) adapted to hydraulically connect said capture cells (17) to one another, the circulation device (5) comprising valves (14) and pumps (13) adapted to be controlled from a controller (15).

13. A method for separating at least one multivalent cationic species from a solution comprising at least said multivalent cationic species and lithium,
said separation method comprising:
at least one capture device (3) comprising an entry (2) and an exit (4) is provided, the capture device (3) comprising, between the entry (2) and the exit (4), a ion exchange microfiber product (21) having a higher affinity for multivalent cations than for monovalent cations,
with a circulation system (5), the solution is circulated from the entry (2) to the exit (4) in contact with the microfiber product (21), said microfiber product (21) capturing said multivalent cationic species.

14. A method according to claim 13, wherein a solution of Lithium Halogenide is provided, especially Chloride, Bromide and/or Iodide, Lithium Sulphate, Lithium Monocarbonate, Lithium Nitrate and/or Lithium Hydroxide, the Lithium bicarbonate content being less than 1%, and notably less than 0.1% in mass.

15. A method according to claim 13, wherein the atmosphere at the level of the microfiber product has a carbon dioxide content less than 0.1% at a total pressure less than 10 bars.

16. A method for producing lithium carbonate comprising a separation method according to claim 13, and wherein the solution at exit is subjected to subsequent treatment by a subsequent processing unit (28).

17. A method of regenerating a microfiber product (21) used for the separation of at least one multivalent cationic species from a solution comprising at least said ionic species and lithium, wherein:
a regeneration circulation device (12) circulates a release product (10) in contact with the microfiber product (21), said ion exchange microfiber product (21) thus releasing said multivalent cationic species,
the regeneration circulation device (12) circulates a recharge product (11) comprising lithium in contact with the microfiber product (21), said microfiber product (21) then charging with lithium.

18. (canceled)
